(19) United States
(12) Patent Application Publication
(10) Pub. No.: US 2017/0091848 A1
(43) Pub. Date: Mar. 30, 2017

(54) METHOD AND SYSTEM FOR RECOMMENDATION OF ASSOCIATION OF SOFTWARE APPLICATIONS

(71) Applicant: SVG Media Pvt Ltd, New Delhi (IN)

(72) Inventors: Vaibhav PANDEY, Gurgaon (IN); Siddharth PURI, Gurgaon (IN)

(21) Appl. No.: 15/063,386

(22) Filed: Mar. 7, 2016

(30) Foreign Application Priority Data
Sep. 24, 2015 (IN) 3050/DEL/2015

(51) Int. Cl. G06Q 30/06; H04L 12/24; H04L 29/08

(52) U.S. Cl. CPC G06Q 30/0631; H04L 67/10; H04L 41/20; H04L 41/12

(57) ABSTRACT

A computer-implemented method for recommendation of association between plural applications unifies an application programming interface associated with each of the plural applications. The computer-implemented method also classifies an application programming interface that is associated with each of the applications. Each application is also classified into a corresponding category. The computer-implemented method also recommends one or more application programming interfaces associated with the one or more categories to an application provider. The application provider is also associated with each of the application programming interfaces. The computer-implemented method also associates the application programming interface associated with each of the applications with a recommended one or more application programming interfaces.

### INTRODUCTION

The present invention relates to the field of mobile applications. More specifically, the present disclosure relates to a method and system for recommending association between plural applications.

Over the last few years, there has been an accelerated growth in the number of communication devices. These communication devices include smart phone, tablets, laptop and the like. In addition, these communication devices enable users to access various numbers of mobile applications. In general, the users access these mobile applications for serving their day to day needs. The users prefer using these mobile applications rather than making any physical effort. Moreover, these mobile applications are provided by various online developers and companies. These companies are dedicated towards providing users with various day to day services such as travelling, food, house cleaning and the like.

Going further, these companies provide their services and products for marketing purposes and revenue generation. The revenue is generated based on an amount charged by these companies when the users avail the services. The users access these applications on their communication devices and select a corresponding desired service. Further, these services correspond to a specific set of on demand services. Also, each of these services falls under a specific class or category of services. In addition, these services include food based services, travelling based services, house work based services, housing services and the like.

Further, each application is built based on a certain platform and each platform has some pre-defined entities or a foundation on which the applications are going to be developed. Furthermore, each entity is defined or developed based on a type of the application. These entities are commonly referred to as an application programming interface which is used by every application developer for developing any type of application. In general, the application programming interface is a set of routines, protocols and tools which are used by various application developers to develop mobile applications. The application programming interfaces are configured for performing basic functions of the mobile applications.

Nowadays, many application developers or providers have started providing their application programming interfaces for their applications for other developers to some extent. The application developers allow other developers to utilize their application programming interface for running their business. For example, an application developer may utilize Google Maps API on their application for providing real time directions for users. Moreover, these are open source APIs which can be used by various application developers for building their application.

Presently, many companies have not exposed their application programming interfaces to be utilized by other developers. However, a number of companies have started dealing exclusively with other companies by enabling them to utilize or link their application programming interface in their applications. The companies have started linking their application programming interfaces with the applications programming interfaces of other companies. Moreover, a single application developer may provide its application programming interface to more than one company based on their choice. In addition, the company needs to physically approach all the companies with whom it wants to deal with. Further, the sharing of application programming interfaces is done for maximizing revenue. The companies dealing in sharing of their application programming interfaces share the profit as well based on a mutual contract between them.

The existing systems and methods for linking various application programming interfaces with each other are inefficient. There is no such platform present in the art which reduces the need for the application providers to physically approach other application providers in order to deal with them. Moreover, the application developers have no idea about which type of application programming interface they should link with in order to generate more revenue. In addition, the application developers do not take into account various locations where the linking would result in generation of more revenue. The application developers have no idea about the best locations where their service can generate more revenue after collaborating with a certain category of application programming interface. Further, the application developers do not take into consideration a price associated with the various services while collaborating with various other developers. Furthermore, the application developers do not have the provision to choose between a set of application programming interfaces for linking. This leads to wastage of time and investment and results in loss of business. The present systems and methods do not recommend the application developers with various types or categories of application programming interfaces. The application developers have no idea about linking with which category of application programming interface.

In the light of the above stated discussion, there is a need for system that overcomes the above stated disadvantages.

### SUMMARY

In one aspect, the present disclosure provides a computer-implemented method that recommends an association between plural applications. The computer-implemented method unifies an application programming interface associated with each of the plurality of applications with a processor. In addition, the computer-implemented method classifies the application programming interface associated with each of the plurality of applications with the processor. Each of the plurality of application is classified into a corresponding category of application of one or more categories of applications associated with the corresponding plurality of applications. Moreover, the computer-implemented method recommends one or more application programming interfaces associated with the one or more categories of applications to an application provider with the processor. The application provider is associated with each of the corresponding application programming interface associated with a corresponding application of the plurality of applications. Further, the computer-implemented method associates the application programming interface associated with each of the plurality of applications with the recommended one or more application programming interfaces. The one or more application programming interfaces are associated with the one or more categories of applications. Furthermore, the recommendation is done based on a pre-defined set of rules. Also, the recommendation is done in real time. In addition, the association is done by cross linking the application programming interface with the recommended one or more application programming interfaces. Moreover, the association is done in the real time based on the pre-defined set of rules.

In another embodiment, the computer-implemented method further receives the application programming interface associated with each of the plurality of applications with the processor. In addition, the application programming interface is received from a corresponding application server associated with each of the corresponding plurality of applications.

In another embodiment, the classification further includes determination of the corresponding category of application for the application programming interface associated with each of the plurality of applications. Each of the plurality of applications is an on demand service application.

In another embodiment, the recommendation further includes recommending one or more application programming interfaces associated with a plurality of categories of applications to the application provider.

In another embodiment, an application programming interface associated with a first category of application is associated with a recommended application programming interface associated with a second category of application. The first category of application is distinct from the second category of applications.

In another embodiment, the application programming interface associated with the first category of application is associated with a recommended plurality of application programming interfaces. The recommended plurality of application programming interfaces is associated with the plurality of categories of applications. In addition, the first category of application is distinct from each of the plurality of categories of application. Also, each category of application of the plurality of categories of application is a distinct category of application.

In another embodiment, the pre-defined set of rules includes a price based rule, a location based rule and a time based rule. The pre-defined set of rules is defined by an administrator.

In another embodiment, the pre-defined set of rules is defined dynamically based on one or more characteristics associated with each of the plurality of applications. The one or more characteristics includes a price associated with one or more services provided by each of the plurality of applications and one or more locations at which the one or more services being available. In addition, the one or more characteristics include a range of time between which the one or more services being available.

In another embodiment, the recommendation of the one or more application programming interfaces is done based on a combination of the pre-defined set of rules.

In another embodiment, the computer-implemented method further stores the application programming interface associated with each of the plurality of applications and each of the categorized application programming interfaces. In addition, the computer-implemented method stores each of the consolidated application programming interfaces and each of the recommended one or more application programming interfaces. Also, the computer-implemented method stores each of the cross linked application programming interfaces and the pre-defined set of rules.

In another aspect, the present invention provides a computer-program product for recommendation of association between a plurality of applications. The computer-program product includes a computer readable storage medium. The computer readable storage medium has a computer program stored thereon. The computer-program product unifies an application programming interface associated with each of the plurality of applications. In addition, the computer-program product classifies the application programming interface associated with each of the plurality of applications. Each of the plurality of application is classified into a corresponding category of application of one or more categories of applications associated with the corresponding plurality of applications. Moreover, the computer-program product recommends one or more application programming interfaces associated with the one or more categories of applications to an application provider. The application provider is associated with each of the corresponding application programming interface associated with a corresponding application of the plurality of applications. Further, the computer-program product associates the application programming interface associated with each of the plurality of applications with the recommended one or more application programming interfaces. The one or more application programming interfaces are associated with the one or more categories of applications. Furthermore, the recommendation is done based on a pre-defined set of rules. Also, the recommendation is done in real time. In addition, the association is done by cross linking the application programming interface with the recommended one or more application programming interfaces. Moreover, the association is done in the real time based on the pre-defined set of rules.

In another embodiment, the computer-program product further receives the application programming interface associated with each of the plurality of applications with the processor. In addition, the application programming interface is received from a corresponding application server associated with each of the corresponding plurality of applications.

In another embodiment, the classification further includes determination of the corresponding category of application for the application programming interface associated with each of the plurality of applications. Each of the plurality of applications is an on demand service application.

In yet another aspect, the present invention provides a system for recommendation of association between a plurality of applications. The system includes a unification engine in a processor. The unification engine unifies an application programming interface associated with each of the plurality of applications. In addition, the system includes a classification engine in the processor. The classification engine classifies the application programming interface associated with each of the plurality of applications. Each of the plurality of application is classified into a corresponding category of application of one or more categories of applications associated with the corresponding plurality of applications. Moreover, the system includes a recommendation engine in the processor. The recommendation engine recommends one or more application programming interfaces associated with the one or more categories of applications to an application provider. The application provider is associated with each of the corresponding application programming interface associated with a corresponding application of the plurality of applications. Further, the system includes an association module in the processor. The association module associates the application programming interface associated with each of the plurality of applications with the recommended one or more application programming interfaces. The one or more application programming interfaces are associated with the one or more categories of applications. Furthermore, the recommendation is done based on a pre-defined set of rules. Also, the recommendation is done in real time. In addition, the association is done by cross linking the application programming interface with the recommended one or more application programming interfaces. Moreover, the association is done in the real time based on the pre-defined set of rules.

In another embodiment, the system further includes a receiving module in the processor. The receiving module receives the application programming interface associated with each of the plurality of applications. In addition, the application programming interface is received from a corresponding application server associated with each of the corresponding plurality of applications.

In another embodiment, the classification engine further includes a determination module in the processor. The determination module determines the corresponding category of application for the application programming interface associated with each of the plurality of applications. Each of the plurality of applications is an on demand service application.

In another embodiment, the recommendation engine further recommends one or more application programming interfaces associated with a plurality of categories of applications to the application provider.

In another embodiment, an application programming interface associated with a first category of application is associated with a recommended application programming interface associated with a second category of application. The first category of application is distinct from the second category of applications.

In another embodiment, the application programming interface associated with the first category of application is associated with a recommended plurality of application programming interfaces. The recommended plurality of application programming interfaces is associated with the plurality of categories of applications. In addition, the first category of application is distinct from each of the plurality of categories of application. Also, each category of application of the plurality of categories of application is a distinct category of application.

In another embodiment, the system further includes a database in the processor. The database stores the application programming interface associated with each of the plurality of applications and each of the categorized application programming interfaces. In addition, the database stores each of the consolidated application programming interfaces and each of the recommended one or more application programming interfaces. Also, the database stores each of the cross linked application programming interfaces and the pre-defined set of rules.

### BRIEF DESCRIPTION OF THE DRAWINGS

Having described the invention in general terms, reference is now made to the accompanying drawings, which are not necessarily drawn to scale, and wherein:

FIG. 1 illustrates a general overview of a system for recommendation of association between plural applications, in accordance with various embodiments of the present disclosure;

FIG. 2 illustrates a block diagram of a communication device, in accordance with various embodiments of the present disclosure;

FIG. 3A illustrate a block diagram for showing an example of association of recommended one or more application programming interfaces, in accordance with various embodiments of the present disclosure;

FIG. 3B illustrates a portable communication device for showing the association of the recommended one or more application programming interfaces, in accordance with various embodiments of the present disclosure;

FIG. 4 illustrates an additional component of an application integration and recommendation system, in accordance with an embodiment of the present disclosure; and

FIG. 5 illustrates a flowchart for the recommendation of association between a plurality of applications, in accordance with various embodiments of the present disclosure.

It should be noted that the accompanying figures are intended to present illustrations of exemplary embodiments of the present invention. These figures are not intended to limit the scope of the present invention.

### DETAILED DESCRIPTION

In the following description, numerous specific details are set forth to provide a thorough understanding of the present invention. It will be apparent, however, to one skilled in the art that the present invention can be practiced broadly without these specific details. In some instances, structures and devices are shown in block diagram form to provide clarity and to avoid obscuring aspects the present invention.

Reference below to “one embodiment” or “an embodiment” means that a particular feature, structure, or characteristic is included in at least one embodiment of the present invention. The appearance of the phrase “in one embodiment” below does not necessarily refer to the same embodiment, nor are separate or alternative embodiments mutually exclusive. The intent is that a feature of one embodiment may be present alone or in combination with features of other embodiments. Similarly, various described requirements may be applicable to some embodiments but not all embodiments.

Moreover, although the following description contains details for the purpose of describing the invention to meet the pertinent requirements of the U.S. Patent Statute, those skilled in the art will appreciate that many variations of the invention are possible, and are within the scope of this description and the invention. Similarly, although many of the features of the present invention are described in terms of each other, or in conjunction with each other, those skilled in the art will appreciate that many of these features can be used independently. Accordingly, this description meets the requirement of the U.S. Patent Statute, but, where appropriate, is intended to be exemplary, allowing for variations to, and without imposing limitations upon, the present invention.

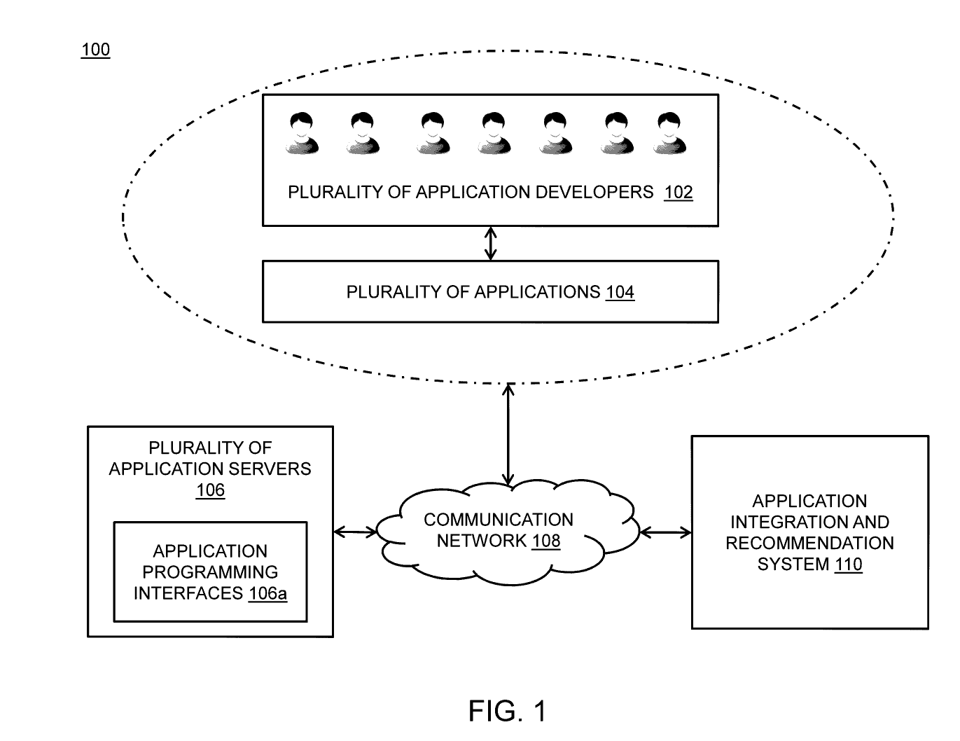

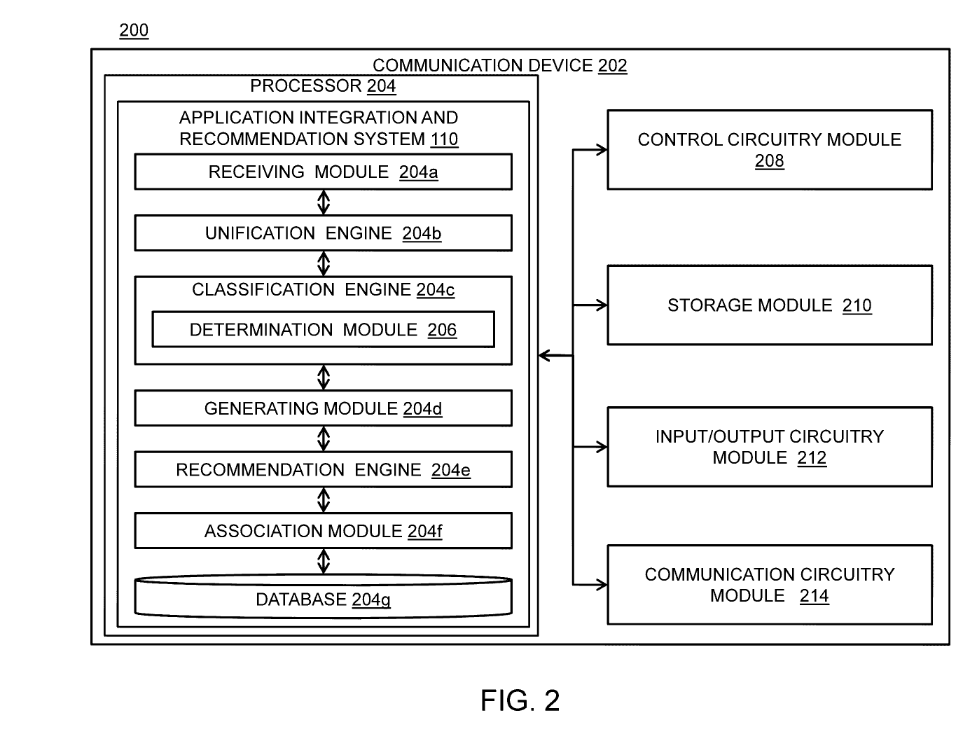

FIG. 1 illustrates a general overview of a system 100 for recommendation of association between a plurality of applications, in accordance with various embodiments of the present disclosure. The system 100 recommends the one or more application programming interfaces to one or more application developers associated with the corresponding one or more applications. Moreover, the system 100 is configured to recommend the one or more application programming interfaces for enabling linking of the one or more application programming interfaces with another application programming interface (as elaborated in the detailed description of FIG. 2).

Going further, the system 100 includes a plurality of applications 104, a plurality of application servers 106, a communication network 108 and an application integration and recommendation system 110. In addition, the application integration and recommendation system 110 recommends the one or more application programming interfaces associated with the corresponding one or more applications. In an embodiment of the present disclosure, the application integration and recommendation system 110 recommends the one or more application programming interfaces for enabling the linking of the one or more application programming interfaces with the another application programming interface. The application integration and recommendation system 110 is a platform for enabling the one or more application developers to manually choose linking with various other one or more application programming interfaces.

In addition, the plurality of applications 104 is associated with a corresponding plurality of application developers 102. In an embodiment of the present disclosure, an application of the plurality of applications 104 is associated an application developer of the plurality of application developers 102. Moreover, each of the plurality of application developers 102 corresponds to any person who is employed in development of one or more mobile applications. In an embodiment of the present disclosure, each of the plurality of application developers 102 is any person who utilizes the one or more application programming interfaces for developing the corresponding plurality of applications 104.

In an embodiment of the present disclosure, each of the plurality of application developers 102 develops an on-demand service application for providing services to one or more users. The plurality of application developers 102 control functioning of the corresponding plurality of applications 104 in real time. Further, each of the plurality of application developers 102 is associated with a corresponding portable communication device. Furthermore, the portable communication device is utilized by each of the plurality of application developers 102 for working on development of the corresponding plurality of applications 104. In an embodiment of the present disclosure, each of the plurality of application developers 102 built the corresponding plurality of applications 104 on a specific platform. The platform includes an android platform, a windows platform, an IOS platform and the like based on a choice of the plurality of application developers 102.

Moreover, each of the plurality of application developers 102 utilizes the portable communication device for viewing the recommended one or more application programming interfaces (as elaborated in the detailed description of FIG. 2). Examples of the portable communication device include a laptop, a desktop computer, a tablet, a personal digital assistant and the like. Each of the plurality of application developers 102 may or may not utilize a different device for viewing the recommended one or more application programming interfaces and a different device for building the plurality of applications 104.

Further, the plurality of applications 104 correspond to a plurality of mobile applications configured to run on a plurality of portable communication devices. Examples of the plurality of portable communication devices include a smart phone, a tablet, a laptop, a smart watch and the like. Moreover, each of the plurality of applications 104 is associated with a corresponding operating system of a plurality of operating systems. The plurality of operating systems include but may not be limited to an Android operating system, iOS, Windows operating system, Bada operating system, Symbian operating system and the like.

Moreover, each of the plurality of portable communication devices is connected to the internet in real time. In an embodiment of the present disclosure, each of the plurality of portable communication devices is associated with a corresponding user of a plurality of users who access one or more applications of the plurality of applications 104. In an embodiment of the present disclosure, the plurality of applications 104 is installed on the corresponding plurality of portable communication devices. In another embodiment of the present disclosure, a number of applications of the plurality of applications 104 are installed in a particular portable communication device of the plurality of portable communication devices based on a choice of a user of the plurality of users.

In addition, each of the plurality of applications 104 is an on demand service application. Further, the on demand service applications include one or more taxi service applications, one or more food based service applications, one or more travel planning based applications, one or more home service based applications and other one or more applications known in the art employed in providing one or more services to the plurality of users through the corresponding portable communication device. In an embodiment of the present disclosure, each of the plurality of users access the one or more applications of the plurality of applications 104 for utilizing the one or more services based on their choice. For example, a user may access a taxi based application for booking a taxi or another user may access a food based application for booking a seat in a restaurant.

Going further, each of the plurality of applications 104 is associated with an application server of the corresponding plurality of application servers 106. In an embodiment of the present disclosure, an application of the plurality of applications 104 is stored in the corresponding application server of the plurality of application servers 106. Moreover, each application server of the plurality of application servers 104 is configured to run the corresponding application of the plurality of applications 104. In addition, the plurality of application servers 106 handles all application related operations between the plurality of users and an organization's backend business applications. In an embodiment of the present disclosure, each of the plurality of application servers 106 is remotely located from each other.

Moreover, each of the plurality of application servers 106 is operated or controlled by the corresponding application developer of the plurality of application developers 102 associated with the application of the plurality of applications 104. In an embodiment of the present disclosure, each of the plurality of application servers 106 is controlled or monitored by a corresponding application administrator at a remote location. In addition, the plurality of application servers 106 is associated with application programming interfaces 106a. In an embodiment of the present disclosure, the application programming interfaces 106a are stored on the plurality of application servers 106. In an embodiment of the present disclosure, each application programming interface of the application programming interfaces 106a is associated with the corresponding application of the plurality of applications 104. The application of the plurality of applications 104 is stored in the corresponding application server of the plurality of application servers 106.

Further, each of the plurality of applications 104 are based on a specific application programming interface designed for a specific type or category of application. The application programming interface is a set of commands, functions and protocols used by the plurality of application developers 102. In an embodiment of the present disclosure, each of the application programming interfaces 106a is an open application programming interface based on a pre-determined criterion (mentioned below in the patent application).

In addition, the plurality of application developers 102 associated with the corresponding plurality of applications 104 allow or enable their corresponding application programming interfaces 106a to be open and utilized by other application developers for running their business. Moreover, one or more application developers of the plurality of application developers 102 may allow an exclusive access of their application programming interfaces 106a to other one or more application providers or developers based on an exclusive dealing between the one or more application developers 102 and the other one or more application providers or developers (as described below in the detailed description of FIG. 2).

Further, each of the application programming interfaces 106a is associated with a specific key. In an embodiment of the present disclosure, each of the plurality of application developers 102 allow the other plurality of application providers to utilize their application programming interface by providing the specific key for gaining access to the application programming interfaces 106a and further utilizing it for business purposes. Furthermore, the specific key is an application programming interface key which is a code passed for identifying a calling program and the corresponding application developer. In addition, the application programming interface key is used for tracking and controlling how the application programming interface is used.

In an embodiment of the present disclosure, each of the application programming interfaces 106a is identified using the application programming interface key. Moreover, the application programming interface key for each of the application programming interfaces 106a is stored in the corresponding application server of the plurality of application servers 106. In addition, the application programming key is fetched from the application server of the corresponding plurality of application servers 106 for gaining access to the application programming interface of the application programming interfaces 106a.

Going further, each of the plurality of application servers 106 is associated with the communication network 108. In an embodiment of the present disclosure, each application of the plurality of applications 104 is associated with the corresponding application server of the plurality of application servers 106 through the communication network 108. Moreover, the communication network 108 enables a medium for transfer of information between each of the plurality of applications 104 and each of the plurality of application servers 108. In an embodiment of the present disclosure, the communication network 108 enables working of the each of the plurality of applications 104.

Further, the medium for communication may be infrared, microwave, radio frequency (RF) and the like. The communication network 108 include but may not be limited to a local area network, a metropolitan area network, a wide area network, a virtual private network, a global area network, a home area network or any other communication network presently known in the art. The communication network 108 is a structure of various nodes or communication devices connected to each other through a network topology method. Examples of the network topology include a bus topology, a star topology, a mesh topology and the like. Accordingly, each of the plurality of applications 104 are accessed by the plurality of users through the communication network 108. Further, each of the plurality of applications 104 is connected to the internet through the communication network 108. In an embodiment of the present disclosure, each of the plurality of portable communication devices are connected to the internet through the communication network 108.

Moreover, each of the plurality of applications 104 is associated with the application integration and recommendation system 110. In an embodiment of the present disclosure, each of the plurality of applications 104 is associated with the application integration and recommendation system 110 through the communication network 108. In addition, each of the plurality of application servers 106 is associated with the application integration and recommendation system 110. Further, each of the plurality of application servers 106 is associated with the application integration and recommendation system 110 through the communication network 108.

Going further, the application integration and recommendation system 110 is linked with each of the plurality of application servers 104. In addition, each of the plurality of application developers 102 associated with the corresponding plurality of application servers 106 enable or allow the application integration and recommendation system 110 to fetch one or more information from each of the plurality of application servers 106 (as mentioned below in the patent application). Moreover, the application integration and recommendation system 110 performs the recommending of the one or more application programming interfaces to each of the plurality of application developers 102.

In addition, the application integration and recommendation system 110 includes a central server for performing one or more operations for performing the recommending of the one or more application programming interfaces to each of the plurality of application developers 102. Further, each of the plurality of application developers 102 is provided an access to the application integration and recommendation system 110. In an embodiment of the present disclosure, the access is provided through a web based interface on the corresponding communication device. Moreover, the web based interface is provided through a website on the corresponding communication device. In an embodiment of the present disclosure, the web based interface is provided through a mobile application on the corresponding communication device.

In addition, the web based interface is provided for enabling each of the plurality of application developers 102 to view the recommended one or more application programming interfaces 106a in real time. The web-based interface provides one or more options to each of the plurality of application developers 102 for choosing to link with an application programming interface of the recommended one or more application programming interfaces. Further, the application integration and recommendation system 110 is configured to allow each of the plurality of application developers 102 to register on the application integration and recommendation system 110. Furthermore, each of the plurality of application developers 102 registers by providing various credentials on the application integration and recommendation system 110.

In addition, each of the plurality of application developers 102 registers by paying a pre-defined amount of money through the web-based interface. The plurality of application developers 102 may pay the pre-defined amount of money through a credit card, debit card, net banking and the like. Further, the application integration and recommendation system 110 is configured to fetch the application programming interface associated with each of the plurality of applications 104 (described below in the patent application). Furthermore, the application integration and recommendation system 110 is configured to consolidate the application programming interface associated with each of the plurality of applications 104 (mentioned below in the patent application).

Moreover, the application integration and recommendation system 110 classifies each of the application programming interfaces 106a into a corresponding category of applications of the one or more categories of applications based on a first pre-defined criterion (described below in the detailed description of FIG. 2). In addition, the application integration and recommendation system 110 associates the application programming interface associated with each of the plurality of applications 104 with the recommended one or more application programming interfaces based on a pre-defined set of rules (mentioned below in the detailed description of FIG. 2).

Further, the application integration and recommendation system 110 stores a set of information associated with the one or more operations performed by each of one or more components (described below in the patent application). In an embodiment of the present disclosure, the application integration and recommendation system 110 enables unification of the application programming interfaces 106a associated with the corresponding plurality of applications 104. In an embodiment of the present disclosure, the application integration and recommendation system 110 enables the application of the plurality of applications 104 to utilize the one or more services or features of other one or more application of the plurality of applications 104 at the same time (described in detail in the detailed description of FIG. 2).

It may be noted that in FIG. 1, the application of the plurality of applications 104 is associated with the application developer of the plurality of application developers 102; however, those skilled in the art would appreciate that there are more number of applications associated with the application developer of the plurality of application developers 102. Further, it may be noted that in FIG. 1, the application server of the plurality of application servers 106 is associated with the corresponding application of the plurality of applications 104; however, those skilled in the art would appreciate that there more number of applications associated with a single application server.

FIG. 2 illustrates a block diagram 200 of a communication device 202, in accordance with various embodiments of the present disclosure. The communication device 202 includes a processor 204, a control circuitry module 206, a storage module 208, an input/output circuitry module 210 and a communication circuitry module 212. In an embodiment of the present disclosure, the processor 204 includes one or more components of the application integration and recommendation system 110. Further, the one or more components of the application integration and recommendation system 110 includes a receiving module 204a, a unification engine 204b, a classification engine 204c, a determination module 206, a generating module 204d, a recommendation engine 204e, an association module 204f and a database 204g. It may be noted that to explain the system elements of FIG. 2, references have to be made to the system elements of FIG. 1.

Further, the one or more components of the application integration and recommendation system 110 enable the recommendation of the association between the plurality of applications 104. Going further, each of the plurality of application servers 106 associated with the corresponding plurality of applications 104 is connected to the application integration and recommendation system 110 through the communication network 108. In addition, each of the plurality of application servers 106 includes the application programming interface of the application programming interfaces 106a associated with the corresponding application of the plurality of applications 104. Moreover, the receiving module 204a of the application integration and recommendation system 110 receives the application programming interface associated with each of the plurality of applications 104. In addition, the application programming interface associated with each of the plurality of applications 104 are received in real time.

Further, the application programming interface associated with each of the plurality of applications 104 are received from the corresponding application server of the plurality of application servers 106. In an embodiment of the present disclosure, the application programming interface associated with each of the plurality of applications 104 are received through the communication network 108. The application programming interface associated with each of the plurality of applications 104 is stored in a database associated with each of the plurality of application servers 106.

Moreover, each of the plurality of application developers 102 enables the receiving module 204a to receive their corresponding application interface of the application programming interfaces 106a. In an embodiment of the present disclosure, each of the application programming interfaces 106a are open application programming interfaces for allowing the fetching of the application programming interface associated with each of the plurality of applications 104. In an embodiment of the present disclosure, each of the application programming interfaces 106a is received from a remote location based on a location of each of the plurality of application servers 106.

For example, an application A1 associated with an application programming interface AP1 is stored on an application server S1, an application A2 associated with an application programming interface AP2 is stored on an application server S2, an application A3 associated with an application programming interface AP3 is stored on an application server S3, an application A4 associated with an application programming interface AP4 is stored on an application server S4, an application A5 associated with an application programming interface AP5 is stored on an application server S5 and an application A6 associated with an application programming interface AP6 is stored on an application server S6. Further, the application A1 and the application A2 is associated with a similar category of application C1 (say, taxi service based application), the application A3 and the application A4 is associated with a similar category of application C2 (say, a food service based application) and the application A5 and the application A6 is associated with a similar category of application C3 (say, a home services based application). The receiving module 204a fetches the application programming interface AP1 from the application server S1, the application programming interface AP2 from the application server S2, the application programming interface AP3 from the application server S3, the application programming interface AP4 from the application server S4, the application programming interface AP5 from the application server S5 and the application programming interface AP6 from the application server S6.

Moreover, the unification engine 204b is configured for unify the received application programming interface associated with each of the plurality of applications 104. In an embodiment of the present disclosure, the unification engine 204b accumulates the application programming interface associated with each of the plurality of applications 104. In addition, the unification is performed for allowing each of the plurality of application developers 102 to integrate their application programming interface on the application integration and recommendation system 110.

Also, each application programming interface of the application programming interfaces 106a is associated with a category of application of the one or more categories of applications. In addition, the unification engine 204b consolidates the application programming interfaces associated with each of the plurality of applications 104 at a single place. Also, the unification engine 204b selectively unifies the application programming interface associated with each of the plurality of applications 104 based on the category of application associated with each of the application programming interfaces 106a.

Going further, the unification engine 204b unifies the application programming interface associated with each of the plurality of applications 104 if each of the plurality of applications 104 is the on demand service applications. In an embodiment of the present disclosure, the unification engine 204b does not unify the application programming interface associated with the one or more applications of the plurality of applications 104 which are not on demand service applications. The unification is done at regular intervals of time. In an embodiment of the present disclosure, the unification is done as soon as the application programming interface associated with each of the plurality of applications 104 are received from each of the plurality of application servers 106.

Going further, the classification engine 204c classifies the application programming interface associated with each of the plurality of applications 104. The application programming interface is classified into the corresponding category of application of the one or more categories of applications associated with the corresponding plurality of applications 104. In an embodiment of the present disclosure, the classification engine 204c classifies the application programming interface associated with each of the plurality of applications 104 based on a specific category of application associated with each of the plurality of applications 104.

Moreover, the specific category of application corresponds to a specific category of on demand service applications. Accordingly, the classification is performed based on a pre-defined list of categories of applications pre-stored in the application integration and recommendation system 110. In an embodiment of the present disclosure, the classification engine 204c matches the category of application associated with the corresponding application of the plurality of applications 104 against the pre-defined list of categories of applications and categorizes the application programming interface based on the matching.

Furthermore, information associated with the category of application associated with the application programming interface associated with each of the plurality of applications 104 is fetched along with the application programming interfaces 106a. Also, the application programming interface associated with a same category of application are stored separately from other application programming interface associated with another same category of application. Further, the classification engine 204c includes the determination module 206 determines the corresponding category of application for the application programming interface associated with each of the plurality of applications 104. In an embodiment of the present disclosure, the categorization of the application programming interface associated with each of the plurality of applications 104 is performed after the determination of the category of application associated with each of the plurality of applications 104. The category of application is determined by using the pre-defined list of categories of applications stored in the application integration and recommendation system 110.

In addition, the one or more categories of applications are provided by the corresponding plurality of application servers 106. Moreover, the one or more categories of applications are defined by the application developer associated with each of the plurality of applications 104 monitoring the corresponding application server of the plurality of application servers 106. In an embodiment of the present disclosure, the one or more categories of applications are defined by an administrator associated with the application integrating system 108.

Continuing the above stated example, the unification engine 204b consolidates the application programming interface AP1, the application programming interface AP2, the application programming interface AP3, the application programming interface AP4, the application programming interface AP5 and the application programming interface AP6. Moreover, the classification engine 204c categorizes the application programming interface AP1 and the application programming interface AP2 into the category of application C1, categorizes the application programming interface AP3 and the application programming interface AP4 into the category of application C2 (food service based application) and categorizes the application programming interface AP5 and the application programming interface AP6 into the category of application C3 (home services based application).

Going further, the generation module 204d of the application integration and recommendation system 110 creates a common application programming interface for each of the one or more application programming interfaces categorized into the corresponding distinct category of application. The one or more application programming interfaces associated with the similar category of application are unified and a single application programming interface is created. Moreover, the creation of the common application programming interface allows the application integration and recommendation system 110 to enable a cross relationship between the one or more application programming interfaces associated with a first distinct category of application and the one or more application programming interfaces associated with a second distinct category of application.

Further, the recommendation engine 204e recommends the one or more application programming interfaces associated with the one or more categories of applications to the application provider associated with each of the corresponding application programming interface. Furthermore, the recommendation is done based on the pre-defined set of rules. In addition, the recommendation is done in real time. The one or more application programming interfaces are recommended for allowing each of the plurality of application developers 102 to choose for linking with the one or more application programming interfaces of their choice in real time.

Moreover, the recommendation engine is 204e recommends the one or more application programming interfaces associated with the plurality of categories of applications to the application provider associated with each of the plurality of applications 104. In addition, each of the plurality of application developers 102 views the recommended one or more application programming interfaces on the corresponding communication device. The plurality of application developers 102 views the recommended one or more application programming interfaces on the website associated with the application integration and recommendation system 110. In an embodiment of the present disclosure, each of the plurality of application developers 102 views the recommended one or more application programming interfaces on the mobile application associated with the application integration and recommendation system 110.

In addition, the pre-defined set of rules includes a price based rule, a location based rule and a time based rule. The pre-defined set of rules is defined by an administrator associated with the application integration and recommendation system 110. Further, the recommendation of the one or more application programming interfaces is done based on a combination of the pre-defined set of rules. In an embodiment of the present disclosure, the administrator controls the functioning of the application integration and recommendation system 110. The administrator provides the one or more application programming interfaces to each of the plurality of application developers 102. In an embodiment of the present disclosure, the pre-defined set of rules is defined dynamically by the administrator based on one or more characteristics associated with each of the plurality of applications 104.

Further, the one or more characteristics includes a price associated with one or more services provided by each of the plurality of applications 104 and one or more locations at which the one or more services is available. In addition, the one or more characteristics includes a range of time between which the one or more services is available. In an embodiment of the present disclosure, each of the plurality of application developers 102 provides information related to the one or more services. The recommendation engine 204e takes into account this information for recommending the one or more application programming interfaces which may provide huge profits to each of the plurality of application developers 102.

The recommendation engine 204e takes into account the price, the one or more locations and the time at which each of the plurality of application developers 102 provide their service. The recommendation engine 204e combines the pre-defined set of rules with the categorization for providing accurate recommendation to the plurality of application developers. The recommendation engine 204e checks which category of application has similar price, similar location and similar time with a corresponding category of application. The checking is done in order to recommend a best application programming interface.

Going further, the recommendation engine 204e includes a location based engine, a time based engine and a location based engine. Moreover, the location based engine continuously checks for the one or more locations associated with each of the plurality of applications 104. The location based engine provides a feedback related to the one or more locations which are suitable for the application developer where the one or more services will generate larger revenue. Moreover, the location based engine recommends the one or more application programming interfaces or the one or more applications which provide services at one or more desired locations for each of the corresponding application developer.

In addition, the time based engine continuously checks for one or more timings associated with each of the plurality of applications 104. The one or more timings are checked for determining a range of the time of the one or more services provided by each of the plurality of applications 104. The time based engine checks for the one or more applications which are having similar timings with the corresponding application for which the recommendation has to be performed. Moreover, the time based engine recommends the one or more application programming interfaces or the one or more applications which provide services during a desired range of timings for each of the corresponding application developer.

Further, the price based engine continuously checks the price associated with the one or more services provided by each of the plurality of applications 104. Also, the price based engine checks the price associated with the one or more services provided by each of the distinct category of application which are suitable for linking with the corresponding application. The price based engine checks for the one or more applications which are having prices in similarity with the corresponding application for which the recommendation has to be done. Moreover, the price based engine recommends the one or more application which provides the one or more services at a particular desired range of prices for each of the corresponding application developer.

Further, the location base engine, the time based engine and the price based engine work collectively for recommending the one or more application programming interfaces to each of the plurality of application developers 102. The recommendation is done based on the location and the price. In an embodiment of the present disclosure, the recommendation is done based on the location and the time. In another embodiment of the present disclosure, the recommending is done based on the price and the time.

For example, the application integration and recommendation system 110 integrates an application programming interface API1 associated with an application developer A and integrates an application programming interfaces API2 associated with an application developer B. The application programming interface API1 is a food service based application and the application programming interface API2 is a taxi service based application. The recommendation engine 204e recommends the application developer A with an application programming interface API3 and an application programming interface API4 associated with a taxi service category and recommends the application developer B with an application programming interface API5 and an application programming interface API6 associated with a home services category.

Moreover, the association module 204f associates the application programming interface associated with each of the plurality of applications 104 with the recommended one or more application programming interfaces. The recommended one or more application programming interfaces are associated with the one or more categories of applications. The association is done by cross linking the application programming interface associated with each of the plurality of applications 104 with the recommended one or more application programming interfaces. In addition, the association is done in real time based on the pre-defined set of rules. Further, the application programming interface associated with a first category of application is associated with the recommended application programming interface associated with a second category of application. Furthermore, the first category of application is distinct from the second category of application.

Also, the application programming interface associated with the first category of application is associated with a recommended plurality of application programming interfaces associated with the plurality of categories of applications. Accordingly, the first category of application is distinct from each of the plurality of categories of application. In addition, each category of application of the plurality of categories of application is a distinct category of application. In addition, a selective number of the one or more application programming interfaces associated with the first category of application are cross linked with the corresponding application programming interface based on a pre-defined set of rules. In an embodiment of the present disclosure, each of the one or more application programming interfaces associated with the first category of application are cross linked with each of the one or more application programming interfaces associated with the second category of application based on the pre-defined set of rules. Moreover, the one or more application programming interfaces associated with the first category of application are cross linked with the one or more application programming interfaces associated with the plurality of categories of applications. Further, the first category of application is distinct from each of the plurality of categories of applications. In an embodiment of the present disclosure, each category of application of the plurality of categories of applications is a distinct category of application.

The pre-defined set of rules is defined based on a current location of a user accessing the one or more applications of the plurality of applications 104. In addition, the pre-defined set of rules is defined based on a current time of accessing the one or more applications of the plurality of applications 104. Moreover, the pre-defined set of rules is defined based on a gender of the user accessing the one or more applications of the plurality of applications 104. Further, the pre-defined set of rules is defined based on an age of the user accessing the one or more applications of the plurality of applications 104. The pre-defined set of rules is set by an administrator associated with the application integration and recommendation system 110. In an embodiment of the present disclosure, the pre-defined set of rules is set by the application developer associated each of the plurality of applications 104.

In addition, the location based rule is defined for checking availability of service each of the plurality of applications 104 in a particular area where each of the plurality of applications is accessed. Moreover, the time based rule is defined checking availability of services associated with each of the plurality of applications 104 on a current time of accessing the plurality of applications 104. Further, the gender based rules and the age based rule is defined for users belonging to a specific gender and age group who have accessed the plurality of applications 104.

The pre-defined set of rules set by both the administrator and the application developer associated with each of the plurality of applications 104 are taken into account for the association of the recommended one or more application programming interfaces. Furthermore, the association module 204f takes a decision for linking the recommended one or more application programming interfaces associated with a particular common category of applications with the application programming interface associated with another particular common category of applications in real time.

In addition, the cross linking is performed for enabling each application developer to utilize services of other application developers through their application programming interfaces in order to enable the plurality of users to access services of various applications on a single application. Also, the number of applications currently providing service through the single application is based on the pre-defined pre-defined set of rules. Moreover, the application integration and recommendation system 110 enables each application developer to deal with another application developer through the application programming interfaces 106a.

Continuing the above stated example, the association module 204f enables association of the application programming interface AP3 and the application programming interface AP4 to the application developer A and enables linking of the application programming interface API5 and the application programming interface API6.

Going further, the database 204g stores the application programming interface associated with each of the plurality of applications 102 and each of the classified application programming interfaces. In addition, the database 204g stores each of the unified application programming interfaces 106a and each of the recommended one or more application programming interfaces. Further, the database 204g stores each of the associated application programming interfaces and the pre-defined set of rules.

It may be noted that in FIG. 2, various modules of the application integration and recommendation system 110 are shown that illustrates the working of the application integration and recommendation system 110; however those skilled in the art would appreciate that the application integration and recommendation system 110 may have more number of modules that could illustrate overall functioning of the application integration and recommendation system 110.

Going further, the communication device 202 includes any suitable type of portable electronic device. Examples of the communication device 202 include but may not be limited to a personal e-mail device (e.g., a Blackberry™ made available by Research in Motion of Waterloo, Ontario), a personal data assistant (“PDA”), a cellular telephone, a Smartphone, the laptop computer, and the tablet computer. In another embodiment of the present disclosure, the communication device 202 can be a desktop computer.

From the perspective of this disclosure, the control circuitry module 208 includes any processing circuitry or processor operative to control the operations and performance of the communication device 202. For example, the control circuitry module 208 may be used to run operating system applications, firmware applications, media playback applications, media editing applications, or any other application. In an embodiment, the control circuitry module 208 drives a display and process inputs received from the user interface. From the perspective of this disclosure, the storage module 210 includes one or more storage mediums including a hard-drive, solid state drive, flash memory, permanent memory such as ROM, any other suitable type of storage component, or any combination thereof. The storage module 210 may store, for example, media data (e.g., music and video files), application data (e.g., for implementing functions on the communication device 202).

From the perspective of this disclosure, the I/O circuitry module 212 may be operative to convert (and encode/decode, if necessary) analog signals and other signals into digital data. In an embodiment, the I/O circuitry module 210 may also convert the digital data into any other type of signal and vice-versa. For example, the I/O circuitry module 212 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 208, the storage module 210 or any other component of the communication device 202. It may be noted that the I/O circuitry module 212 is illustrated in FIG. 2 as a single component of the communication device 202; however those skilled in the art would appreciate that several instances of the I/O circuitry module 212 may be included in the communication device 202.

The communication device 202 may include any suitable interface or component for allowing the users to provide inputs to the I/O circuitry module 212. The communication device 202 may include any suitable input mechanism. Examples of the input mechanism include but may not be limited to a button, keypad, dial, a click wheel, and a touch screen. In an embodiment, the communication device 202 may include a capacitive sensing mechanism, or a multi-touch capacitive sensing mechanism. In an embodiment, the communication device 202 may include specialized output circuitry associated with output devices such as, for example, one or more audio outputs. The audio output may include one or more speakers built into the communication device 202, or an audio component that may be remotely coupled to the communication device 202.

The one or more speakers can be mono speakers, stereo speakers, or a combination of both. The audio component can be a headset, headphones or ear buds that may be coupled to the communication device 202 with a wire or wirelessly. In an embodiment, the I/O circuitry module 212 may include display circuitry for providing a display visible to the users. For example, the display circuitry may include a screen (e.g., an LCD screen) that is incorporated in the communication device 202. The display circuitry may include a movable display or a projecting system for providing a display of content on a surface remote from the communication device 202 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 208. Alternatively, the display circuitry may be operative to provide instructions to a remote display. In addition, the communication device 202 includes the communication circuitry module 214. The communication circuitry module 214 may include any suitable communication circuitry operative to connect to a communication network and to transmit communications (e.g., voice or data) from the communication device 202 to other devices within the communications network. The communication circuitry module 214 may be operative to interface with the communication network using any suitable communication protocol. Examples of the communication protocol include but may not be limited to Wi-Fi, Bluetooth RTM, radio frequency systems, infrared, LTE, GSM, GSM plus EDGE, CDMA, and quadband.

In an embodiment, the communication circuitry module 214 may be operative to create a communications network using any suitable communications protocol. For example, the communication circuitry module 214 may create a short-range communication network using a short-range communications protocol to connect to other devices. For example, the communication circuitry module 214 may be operative to create a local communication network using the Bluetooth, RTM protocol to couple the communication device 202 with a Bluetooth, RTM headset.

It may be noted that the computing device is shown to have only one communication operation; however, those skilled in the art would appreciate that the communication device 202 may include one more instances of the communication circuitry module 214 for simultaneously performing several communication operations using different communication networks. For example, the communication device 202 may include a first instance of the communication circuitry module 214 for communicating over a cellular network, and a second instance of the communication circuitry module 214 for communicating over Wi-Fi or using Bluetooth RTM.

In an embodiment of the present disclosure, the same instance of the communication circuitry module 214 may be operative to provide for communications over several communication networks. In an embodiment, the communication device 202 may be coupled to a host device for data transfers, syncing the communication device 202, software or firmware updates, providing performance information to a remote source (e.g., providing riding characteristics to a remote server) or performing any other suitable operation that may require the communication device 202 to be coupled to the host device. Several computing devices may be coupled to a single host device using the host device as a server. Alternatively or additionally, the communication device 202 may be coupled to the several host devices (e.g., for each of the plurality of the host devices to serve as a backup for data stored in the communication device 202).

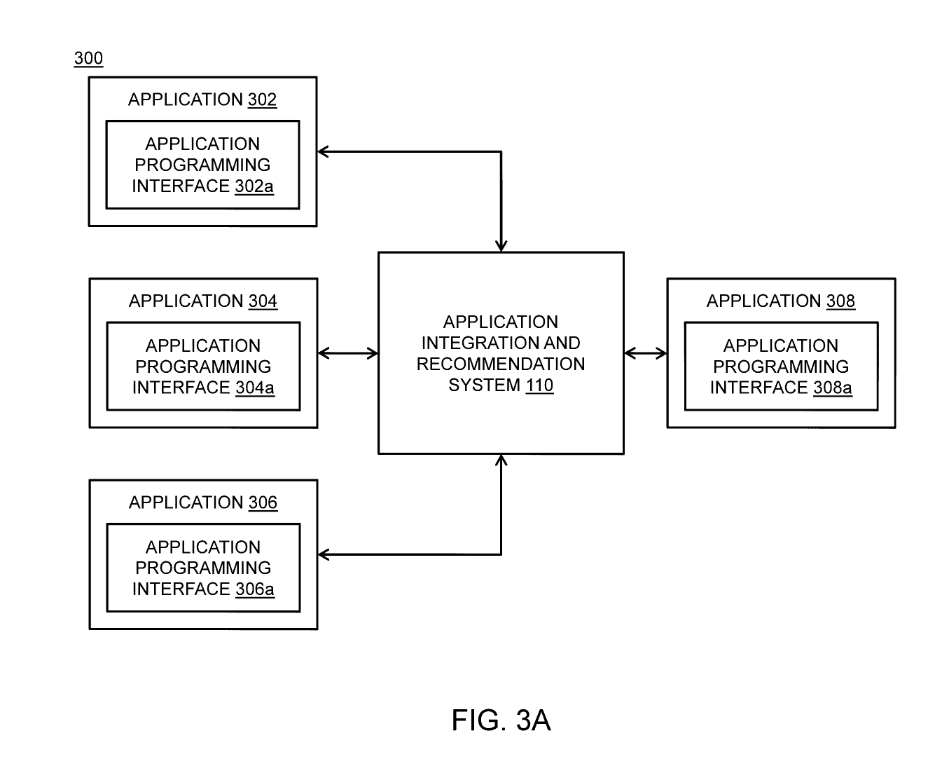

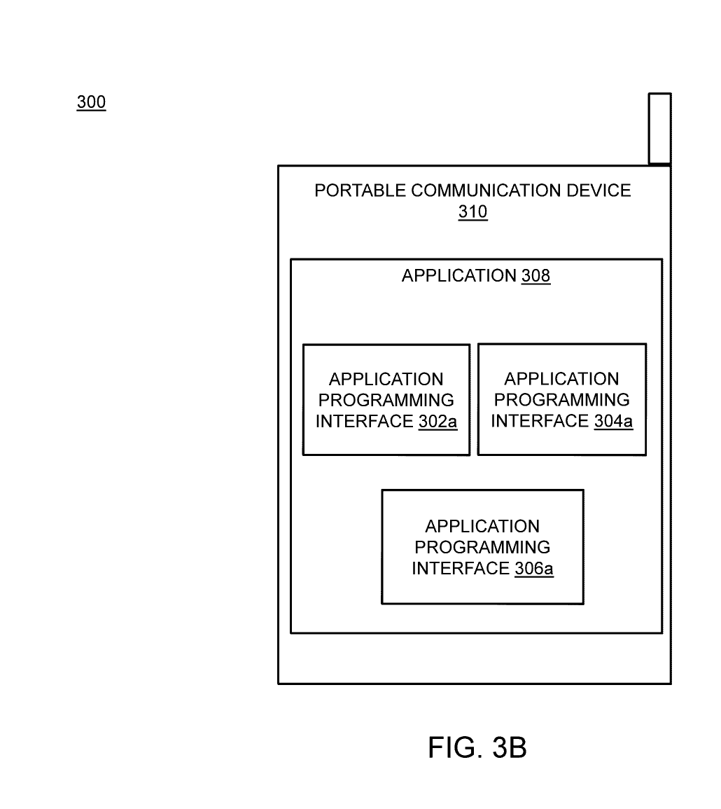

FIG. 3A illustrates a block diagram 300 for showing an example of the association of the recommended one or more application programming interfaces associated with the corresponding category of the one or more categories of applications, in accordance with various embodiments of the present disclosure. It may be noted that to explain the system elements of FIG. 3A, references will be made to the system elements of FIG. 1 and FIG. 2. The block diagram 200 includes an application 302, an application 304, an application 306, an application 308 and an application integration and recommendation system 110.

Further, the application 302 is associated with an application programming interface 302a, the application 304 is associated with an application programming interface 304a, the application 306 is associated with an application programming interface 306a and the application 308 is associated with an application programming interface 308a. Moreover, the application programming interface 302a, the application programming interface 304a and the application programming interface 306a are recommended by the recommendation engine 210 for the cross linking with the application programming interface 308a.

The association module 204f cross links the application programming interface 308a with the application programming interface 302a, the application programming interface 304a and the application programming interface 306a. In addition, the application integration and recommendation system 110 links the application programming interface 308a with the application programming interface 302a, the application programming interface 304a and the application programming interface 306a based on the pre-defined set of rules.

FIG. 3B illustrates a portable communication device 314 for showing the association of the recommended one or more of application programming interfaces, in accordance with various embodiments of the present disclosure. It may be noted that to explain the system elements of FIG. 3C, references will be made to the system elements of FIG. 1, FIG. 2 and FIG. 3A. The portable communication device 310 includes the application 308 installed on the portable communication device 310. In addition, the portable communication device 310 includes a smart phone, a tablet, a laptop and the like. In an embodiment of the present disclosure, the portable communication device 310 is associated with a specific type of operating system.

Going further, the application programming interface 308a associated with the application 308 is linked with the recommended application programming interface 302a, the recommended application programming interface 304a and the recommended application programming interface 306a. In addition, the application 308 is accessed by the user of the plurality of users presently in any location and on a specified time for requesting any service. The application integration and recommendation system 110 displays the services of each of the application 302, the application 304 and the application 306 on the application 308 on a screen of the portable communication device 310. The user may choose services from any application based on his/her choice.

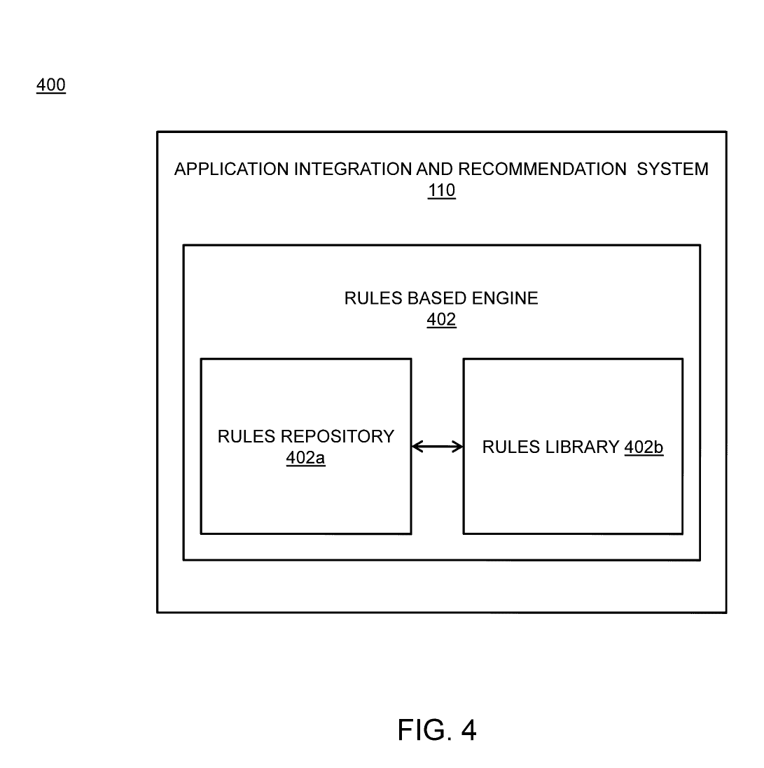

FIG. 4 illustrates a block diagram 400 for showing an additional component of the application integration and recommendation system 110, in accordance with various embodiments of the present disclosure. The additional component of the integration and recommendation system 110 includes a rules based engine 402. In addition, the rules based engine 402 is configured to define the pre-defined set of rules for enabling the cross linking of the one or more application programming interfaces.

The administrator associated with the integration and recommendation system 110 sets the pre-defined set of rules through the rules based engine 402. Moreover, the pre-defined set of rules is updated through the rules based engine 402. In addition, the pre-defined set of rules is stored in the rules based engine 402. Further, the rules based engine 402 includes a rules repository 402a and a rules library 402b. Furthermore, the rules repository 402a stores the pre-defined set of rules and the rules library 402b is used for setting the pre-defined set of rules.

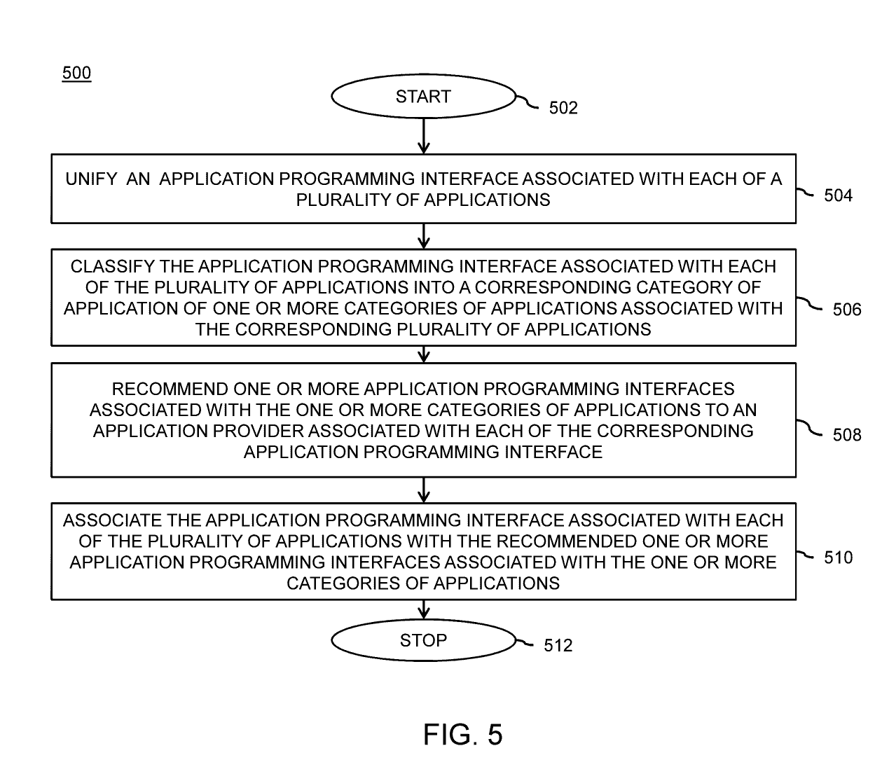

FIG. 5 illustrates a flowchart 500 for the recommendation of the association between the plurality of applications 102, in accordance with various embodiments of the present disclosure. It may be noted that to explain the process steps of the flowchart 500, references will be made to the system elements of the FIG. 1 and FIG. 2. The flowchart 500 initiates at step 502. At step 504, the unification engine 204b unifies the application programming interface associated with each of the plurality of applications 102. At step 506, the classification engine 204c classifies the application programming interface associated with each of the plurality of applications 102 into a corresponding category of application of one or more categories of applications. At step 508, the recommendation engine 204e recommends the one or more application programming interfaces associated with the one or more categories of applications to the application provider. The application provider is associated with each of the corresponding application programming interfaces. At step 510, the association module 204f associates the application programming interface associated with each of the plurality of applications with the recommended one or more application programming interfaces. The recommended one or more application programming interfaces are associated with the one or more categories of applications. The flowchart 500 terminates at step 512.

It may be noted that the flowchart 500 is explained to have above stated process steps; however, those skilled in the art would appreciate that the flowchart 500 may have more/less number of process steps which may enable all the above stated embodiments of the present disclosure.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for recommendation of association between a plurality of applications, the computer-implemented method comprising:
unifying, with a processor, an application programming interface associated with each of the plurality of applications;
classifying, with the processor, the application programming interface associated with each of the plurality of applications into a corresponding category of application of one or more categories of applications associated with the corresponding plurality of applications;
recommending, with the processor, one or more application programming interfaces associated with the one or more categories of applications to an application provider associated with each of the corresponding application programming interface, wherein the recommending being done based on a pre-defined set of rules and wherein the recommending being done in real time; and
associating, with the processor, the application programming interface associated with each of the plurality of applications with the recommended one or more application programming interfaces associated with the one or more categories of applications, wherein the associating being done by cross linking the application programming interface with the recommended one or more application programming interfaces, wherein the associating being done in the real time based on the pre-defined set of rules.

2. The computer-implemented method as recited in claim 1, further comprising receiving, with the processor, the application programming interface associated with each of the plurality of applications, wherein the application programming interface being received from a corresponding application server associated with each of the corresponding plurality of applications.

3. The computer-implemented method as recited in claim 1, wherein the classification further comprises determining, with the processor, the corresponding category of application for the application programming interface associated with each of the plurality of applications and wherein each of the plurality of applications being an on demand service application.

4. The computer-implemented method as recited in claim 1, wherein the recommendation further comprises recommending one or more application programming interfaces associated with a plurality of categories of applications to the application provider associated with each of the plurality of application.

5. The computer-implemented method as recited in claim 1, wherein an application programming interface associated with a first category of application being associated with a recommended application programming interface associated with a second category of application, wherein the first category of application being distinct from the second category of applications.

6. The computer-implemented method as recited in claim 5, wherein the application programming interface associated with the first category of application being associated with a recommended plurality of application programming interfaces associated with the plurality of categories of applications, wherein the first category of application being distinct from each of the plurality of categories of application and wherein each category of application of the plurality of categories of application being a distinct category of application.

7. The computer-implemented method as recited in claim 1, wherein the pre-defined set of rules comprises a price based rule, a location based rule and a time based rule, wherein the pre-defined set of rules being defined by an administrator.

8. The computer-implemented method as recited in claim 7, wherein the pre-defined set of rules being defined dynamically based on one or more characteristics associated with each of the plurality of applications, wherein the one or more characteristics comprises a price associated with one or more services provided by each of the plurality of applications, one or more locations at which the one or more services being available and a range of time between which the one or more services being available.

9. The computer-implemented method as recited in claim 1, wherein the recommendation of the one or more application programming interfaces being done based on a combination of the pre-defined set of rules.

10. The computer-implemented method as recited in claim 1, further comprising storing, with the processor, the application programming interface associated with each of the plurality of applications, each of the classified application programming interface, each of the unified application programming interfaces, each of the recommended one or more application programming interfaces, each of the associated application programming interfaces and the pre-defined set of rules.

11. A computer-program product for recommendation of association between a plurality of applications, the computer-program product comprising:
a computer readable storage medium having a computer program stored thereon for performing the steps of:
unifying an application programming interface associated with each of the plurality of applications;
classifying the application programming interface associated with each of the plurality of applications into a corresponding category of application of one or more categories of applications associated with the corresponding plurality of applications;
recommending one or more application programming interfaces associated with the one or more categories of applications to an application provider associated with each of the corresponding application programming interface, wherein the recommending being done based on a pre-defined set of rules and wherein the recommending being done in real time; and
associating the application programming interface associated with each of the plurality of applications with the recommended one or more application programming interfaces associated with the one or more categories of applications, wherein the associating being done by cross linking the application programming interface with the recommended one or more application programming interfaces, wherein the associating being done in real time based on the pre-defined set of rules.

12. The computer-program product as recited in claim 11, further comprising receiving the application programming interface associated with each of the plurality of applications, wherein the application programming interface being received from a corresponding application server associated with each of the corresponding plurality of applications.

13. The computer-program product as recited in claim 11, wherein the classification further comprises determining the corresponding category of application for the application programming interface associated with each of the plurality of applications and wherein each of the plurality of applications being an on demand service application.

14. A system for recommendation of association between a plurality of applications, the system comprising:
a unification engine in a processor, the unification engine being configured to unify an application programming interface associated with each of the plurality of applications;
a classification engine in the processor, the classification engine being configured to classify the application programming interface associated with each of the plurality of applications into a corresponding category of application of one or more categories of applications associated with the corresponding plurality of applications;
a recommendation engine in the processor, the recommendation engine being configured to recommend one or more application programming interfaces associated with the one or more categories of applications to an application provider associated with each of the corresponding application programming interface, wherein the recommending being done based on a pre-defined set of rules and wherein the recommending being done in real time; and
an association module in the processor, the association module being configured to associate the application programming interface associated with each of the plurality of applications with the recommended one or more application programming interfaces associated with the one or more categories of applications, wherein the associating being done by cross linking the application programming interface with the recommended one or more application programming interfaces, wherein the associating being done in real time based on the pre-defined set of rules.

15. The system as recited in claim 14, further comprising a receiving module in the processor, the receiving module being configured to receive the application programming interface associated with each of the plurality of applications, wherein the application programming interface being received from a corresponding application server associated with each of the corresponding plurality of applications.

16. The system as recited in claim 14, wherein the classification engine further comprises a determination module in the processor, the determination module being configured to determine the corresponding category of application for the application programming interface associated with each of the plurality of applications and wherein each of the plurality of applications being an on demand service application.

17. The system as recited in claim 14, wherein the recommendation engine further recommends one or more application programming interfaces associated with a plurality of categories of applications to the application provider associated with each of the plurality of application.

18. The system as recited in claim 14, wherein an application programming interface associated with a first category of application being associated with a recommended application programming interface associated with a second category of application, wherein the first category of application being distinct from the second category of application.

19. The system as recited in claim 18, wherein the application programming interface associated with the first category of application being associated with a recommended plurality of application programming interfaces associated with the plurality of categories of applications, wherein the first category of application being distinct from each of the plurality of categories of application and wherein each category of application of the plurality of categories of application being a distinct category of application.

20. The system as recited in claim 14, further comprising a database in the processor, the database being configured to store the application programming interface associated with each of the plurality of applications, each of the classified application programming interface, each of the unified application programming interfaces, each of the recommended one or more application programming interfaces, each of the associated application programming interfaces and the set of rules.
